(19) United States
(12) Patent Application Publication
(10) Pub. No.: US 2018/0163358 A1
(43) Pub. Date: Jun. 14, 2018

(54) WATER DIVERSION SYSTEM, METHOD AND APPARATUS

(71) Applicant: Dietzler Construction Corporation, Berthoud, CO (US)

(72) Inventors: Daniel P. Dietzler, Glen Ellyn, IL (US); John P. Dietzler, Denver, CO (US)

(73) Assignee: Dietzler Construction Corporation, Berthoud, CO (US)

(21) Appl. No.: 15/834,744

(22) Filed: Dec. 7, 2017

Related U.S. Application Data
(60) Provisional application No. 62/432,056, filed on Dec. 9, 2016.

(51) Int. Cl. E02B 5/02; E03F 1/00; E02B 3/02; E02B 11/00

(52) U.S. Cl. CPC E02B 5/02; E03F 1/007; F15D 1/065; E02B 11/005; E02B 3/02

(57) ABSTRACT

A water diversion system for a job site in a streambed comprises a cofferdam in the streambed upstream of the job site, at least one, preferably two sections of substantially rigid pipe embedded in the cofferdam, a valve or plug in each pipe section to open or close water flow through the pipe, and at least one, preferably two flexible tubes connected to the downstream ends of the pipe sections, respectively. The flexible tubes are configured to lie on the natural streambed and traverse the job site, substantially without grading or otherwise disturbing the natural streambed. An optional positioning and pull straps can be installed on the flexible tubes to assist with moving the tubes and securing the tube in place under water flows. Water diversion paths around and through the job site can alternated or changed by flipping the valves and/or moving the flexible tubes.

### FIELD OF THE INVENTION

The subject disclosure relates to systems for diversion of streams during construction, and more specifically water diversion systems, methods and apparatus for rough terrain applications characterized by steep grades and changes in slope.

### BACKGROUND OF THE INVENTION

In construction of roads, bridges and other structures it is frequently necessary to divert the flow of rivers, streams, creeks so that a structure may constructed in the river/streambed in substantially dry conditions. Typically, a cofferdam is erected upstream from the primary job site and one or more by-pass channels, conduits, culverts, sluices and/or tunnels are constructed to divert water from the cofferdam around the primary job site and back into the river/stream channel downstream from the job site.

There are many challenges in designing and constructing an effective diversion plan. In particular, corrugated metal pipes (CMP) and other conventional conduits may be unsuitable for rough terrain applications characterized by steep streambed grades, localized streambed variations, and changes in slope. If CMP's or other rigid conduits are used, they will tend to leak at joints connecting them together. Gaskets can be used at joints to reduce leaks, but often cannot eliminate them Minimizing environmental impact is also increasingly important.

### SUMMARY OF THE INVENTION

A basic embodiment of the invention is a water diversion system for a job site in a streambed comprising a cofferdam across the streambed upstream of the job site. The cofferdam has an upstream side and a downstream side. At least one section of substantially rigid pipe is embedded in the cofferdam. At least one flexible tube, such as a high-density polyethylene or reinforced polyethylene liner welded into a tubular shape, is configured for connection to the downstream end of the rigid pipe section and is configured to lie on the existing streambed and traverse the job site. The flexible tube is soft and pliant, yet durable so that it conforms to the natural ground surface, and in particular, conforms to the existing streambed, including rough terrain, localized streambed variations, steep grades and changes in slope, without grading or other disruption of the natural streambed. The flexibility of the tube also facilitates routing the tube through and around the job site on a curved or serpentine path. A valve or plug is engaged with the rigid pipe section and is configured to open or close flow within the pipe section. When the valve is open, water is diverted through the flexible tube around or through the job site on a first path. At a later point in time, e.g., after a portion of construction work has been completed, the valve can be closed and the flexible tube is rerouted along the streambed and around or through the job site on a second path. Flumes or other devices can be used to support parts of the tube if needed.

In a preferred embodiment, two rigid pipe sections, each equipped with valves, are embedded in the cofferdam upstream of a job site in a streambed. A first flexible plastic tube is connected to the downstream end of the first pipe section and is configured to lie on the streambed and traverse the job site on a first path. A second flexible plastic tube is connected to the downstream end of the second pipe section and configured to lie on the streambed and traverse the job site on a second path. Flow can be diverted through either the first or second tubes, or both, by manipulation of the valves. When flow is closed in one of the tubes, it can be rolled up or moved to a different path so as to accommodate construction sequencing.

A basic method of the invention is to construct a cofferdam upstream from a job site, and embed first and second substantially rigid pipes, each having valves, within or at the inlet of the cofferdam. A first flexible tube is connected to the downstream end of the first rigid pipe. The first tube is routed along the natural streambed and around or through a first part of the job site on a first path that terminates downstream from the job site, substantially without disturbing the natural streambed outside of the cofferdam and job site. The second valve is closed and the first valve is opened to cause water to flow through the first tube. A second flexible tube is secured to the downstream end of the second rigid pipe. The second tube is routed along the streambed and around or through a second part of the job site on a second path that terminates downstream from the job site, substantially without disturbing the natural streambed outside of the cofferdam and job site. Later, as construction has progressed, the first valve can be closed and the second valve opened to cause water to flow through the second tube.

There are multiple advantages of the system of the invention. Because the flexible tubes can traverse rough ground with significant grade changes, the amount of grading of the streambed can be minimized or eliminated. This provides a significant reduction of environmental impact in addition to saving costs. Second, the flexible tubes can be fabricated in long lengths, e.g., longer than 100 feet, so that connections between tube sections can be reduced or eliminated. This provides a more structurally sound system, reduces leaks and saves installation costs. Third, the tubes of system can flexibly curve in both horizontal and vertical directions. As a result, the system can be effective in mountain sites having narrow channels, steep and variable grades, and rugged streambeds with holes and the like. Fourth, flipping, alternating or otherwise changing the water diversion paths is simple, quick and cost effective.

Other aspects and features of the invention will become apparent to those of reasonable skill in the art from the following detailed description, as considered in conjunction with the accompanying drawings.

### BRIEF DESCRIPTION OF THE DRAWINGS

FIG. 1 is a schematic plan view of the water diversion system of the invention.

FIG. 2 is an exploded side view of an embodiment of the flexible tube and rigid pipe.

FIG. 3 is a cross sectional view of the flexible tube connected to a substantially rigid pipe.

FIG. 4 is a side view showing a pipe connector connecting two flexible tubes.

FIG. 5 is a side view of another embodiment of the flexible tube and rigid pipe.

FIG. 6 is an exemplary longitudinal cross-sectional view of a flexible tube in a streambed.

FIG. 7 is a diagram showing a first tube routed on a first path in a streambed through a job site.

FIG. 8 is a diagram showing a first tube routed on a first path in the streambed through a job site while construction progresses in a first part of the job site.

FIG. 9 is a diagram showing a second tube routed on a second path in the streambed through a part of the job site after construction has progressed in the first part of the job site.

FIG. 10 is a diagram showing the first tube detached after flow is initiated through the second tube clearing a second part of the job site.

FIG. 11 is a diagram showing construction completed in the second part of the job site.

FIG. 12 is a flow chart of the method of the invention.

### DETAILED DESCRIPTION OF PREFERRED EMBODIMENTS

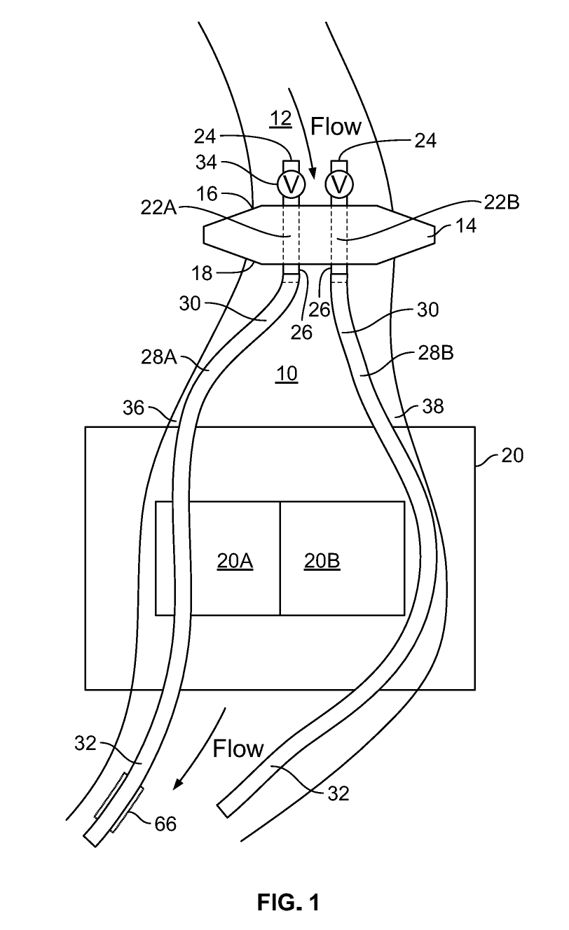

FIG. 1 is a schematic plan view of an embodiment of the invention. A cofferdam 14 is constructed in a streambed 10 upstream from a job site 20. The cofferdam may be constructed from earth, crushed rock, concrete, steel sheet piling, combinations thereof, or any other material or construction technique as are well known in the art. In some cases, a downstream cofferdam can be constructed downstream from the jobsite, but is generally unnecessary. Two substantially rigid pipe sections 22A and 22B are embedded within the upstream cofferdam 14. The pipe sections in one embodiment are corrugated metal pipe (“CMP”), however other types of pipes or conduits may be used, such as precast concrete or substantially rigid plastic pipe. The pipe sections can be corrugated or smooth. Optionally, a steel plate (not shown) can be welded to the upstream end of steel pipe sections, perpendicular to flow, to assisting anchoring the pipe in the streambed and to minimize seepage between the cofferdam and pipe. Flexible tubes 28 are secured to the downstream ends 26 of each pipe section 22, respectively. The flexible tubes 28A and 28B are routed around or through the job site 20 and terminate in the streambed 10 downstream from the job site 20. The diameter of the pipe 22 and flexible tubes 28 are sized to accommodate the flow rate of the stream. More specifically, each pipe/tube combination should be able to handle the full flow rate of the steam during the construction period. Flumes or other devices 66 can be used a needed to support the tube, such as over a deep hole in the streambed. The term “streambed” as used herein is intended to broadly include cannels and embankments of streams, rivers, creeks, ravines, ditches, gullies, canals and other watercourses.

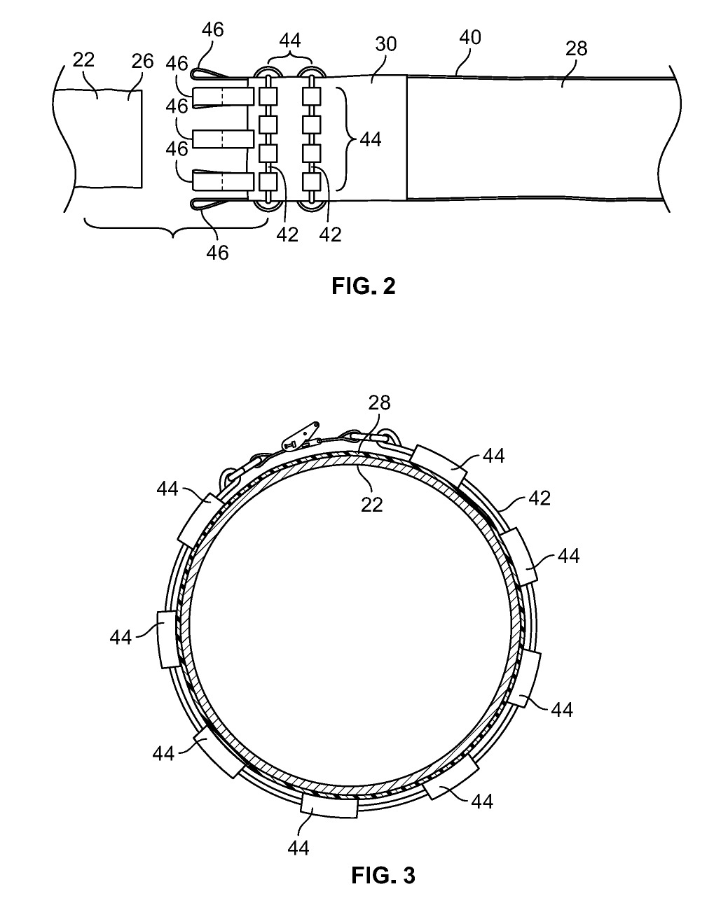

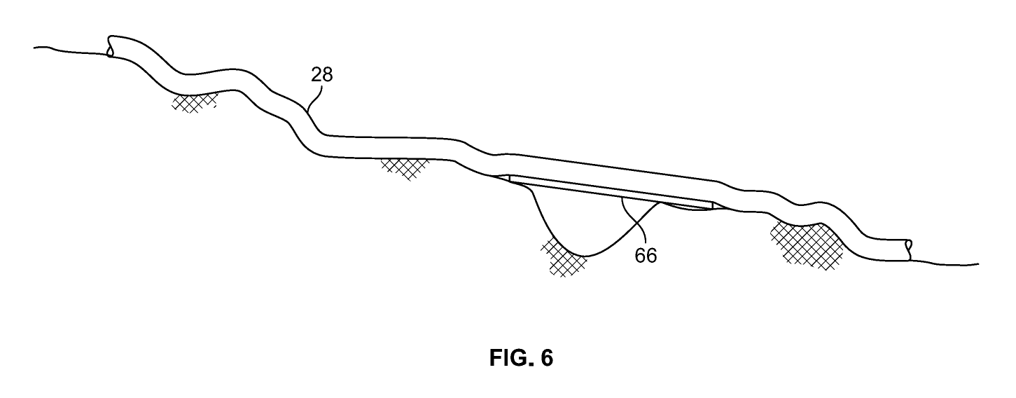

FIGS. 2 and 3 illustrate an embodiment of a flexible tube 28 secured to pipe section 22. The term “flexible tube” as used herein means a soft and pliant, yet durable conduit that conforms to the natural ground surface, and in particular is conformable to rough terrain characterized by steep streambed grades, localized streambed variations, and changes in slope, as shown diagrammatically in FIG. 6. An exemplary flexible tube meeting this definition is fabricated from a durable flexible plastic sheet such as HDPE (high density polyethylene) or RPE (reinforced polyethylene) that is welded into a tubular shape. The tube can be prefabricated offsite, or can be fusion welded in the field by overlapping edges and using a hand held machine to heat the product and melt the seam to create a watertight continuous tube. The tubing has a sufficient thickness, depending on the material, to resist punctures and tears. In one embodiment 45 mil RPE was used. Optionally, a protective layer of filter fabric 40 or the like may be secured on all or a portion of the outer surface of the tube. The length of the tube is dependent on the particular job site. RPE tubes may be formed in essentially any length at the fabrication facility or by using field welding processes. In one embodiment, each tube was 54 inches in diameter and 110 feet long.

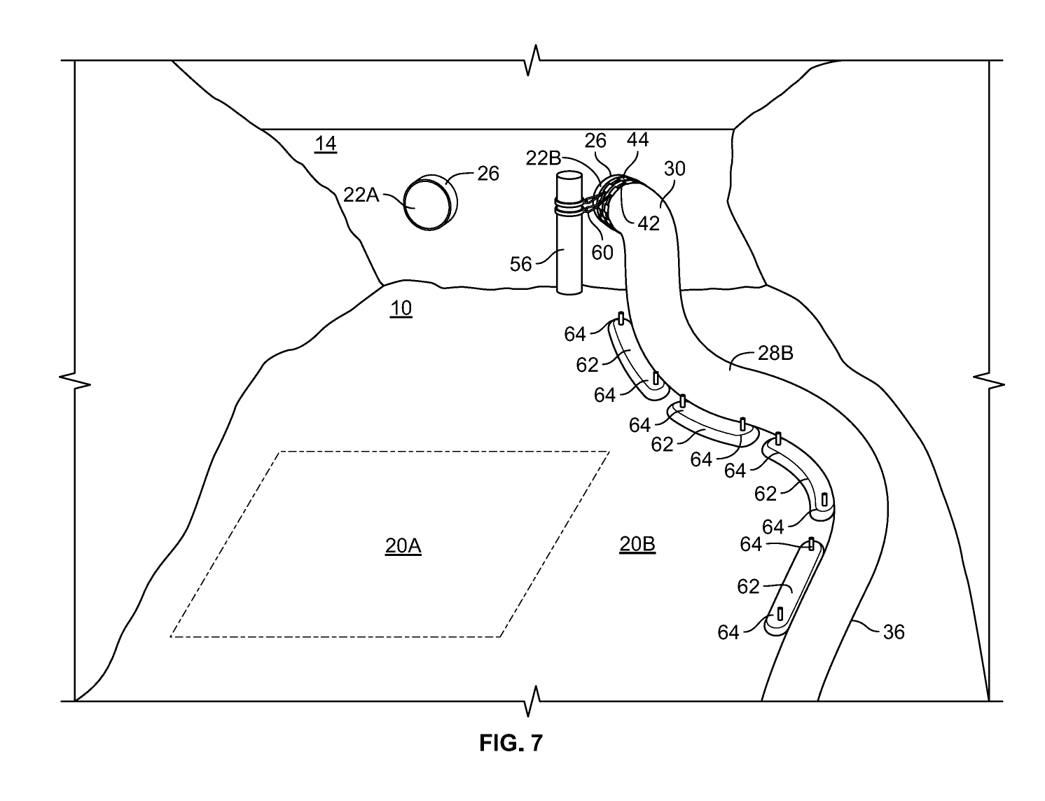

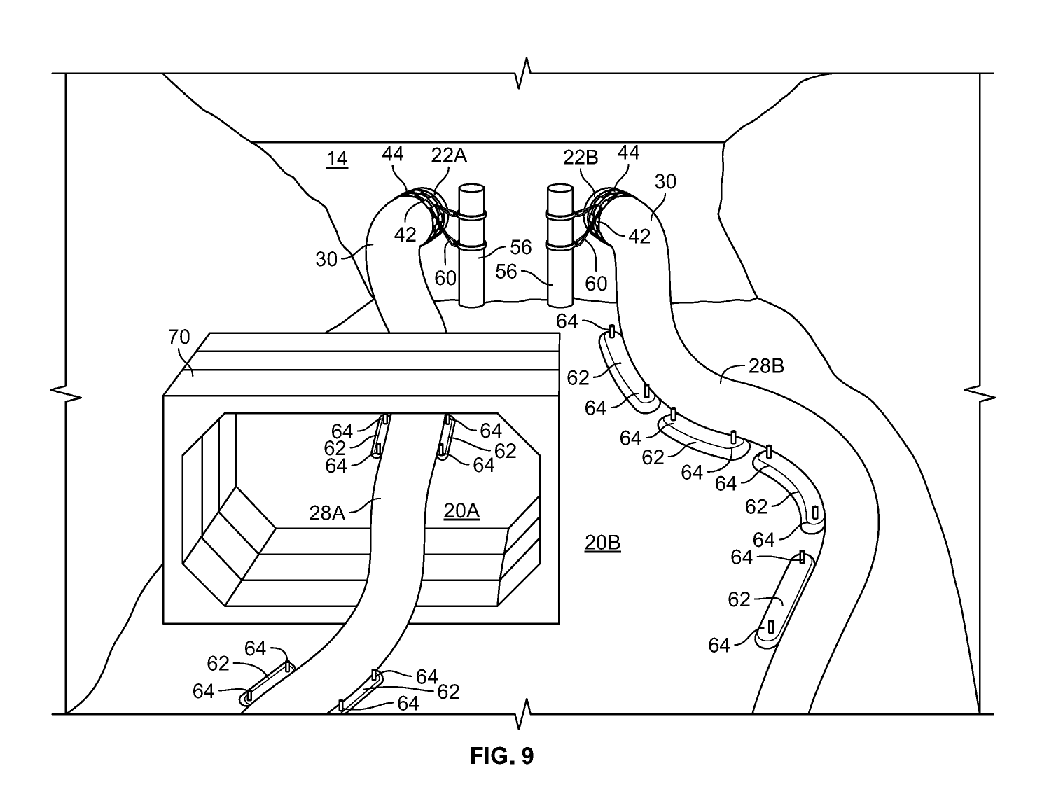

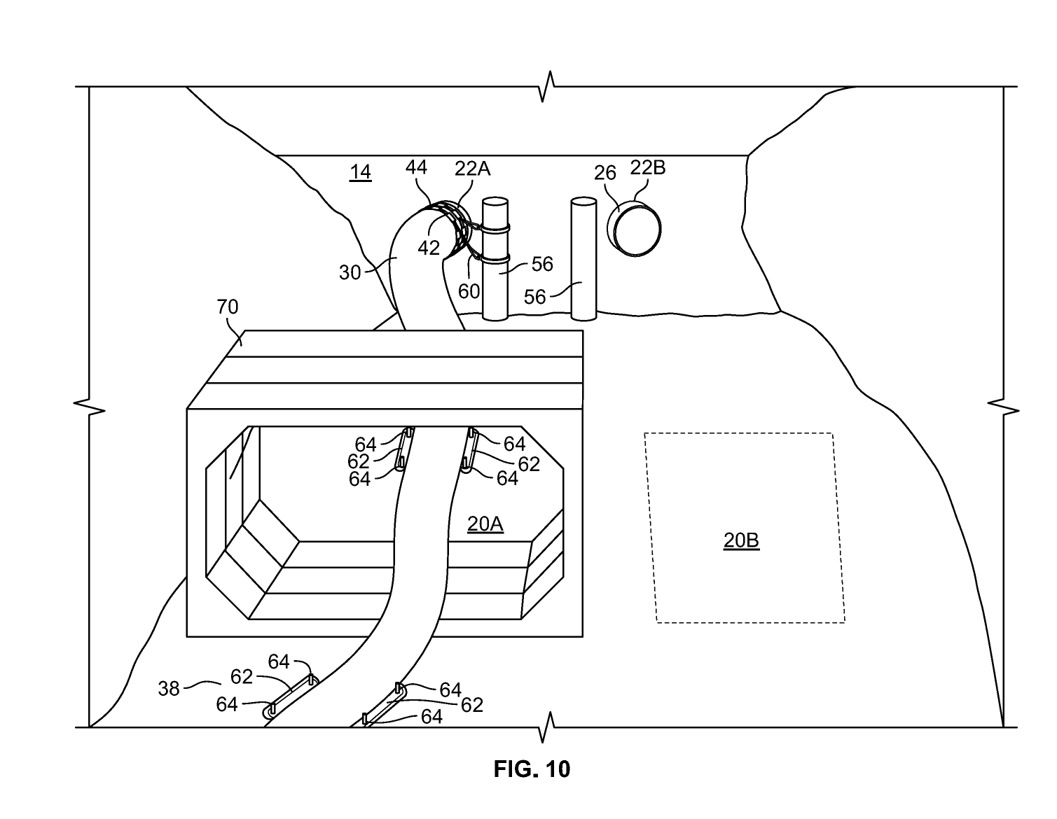

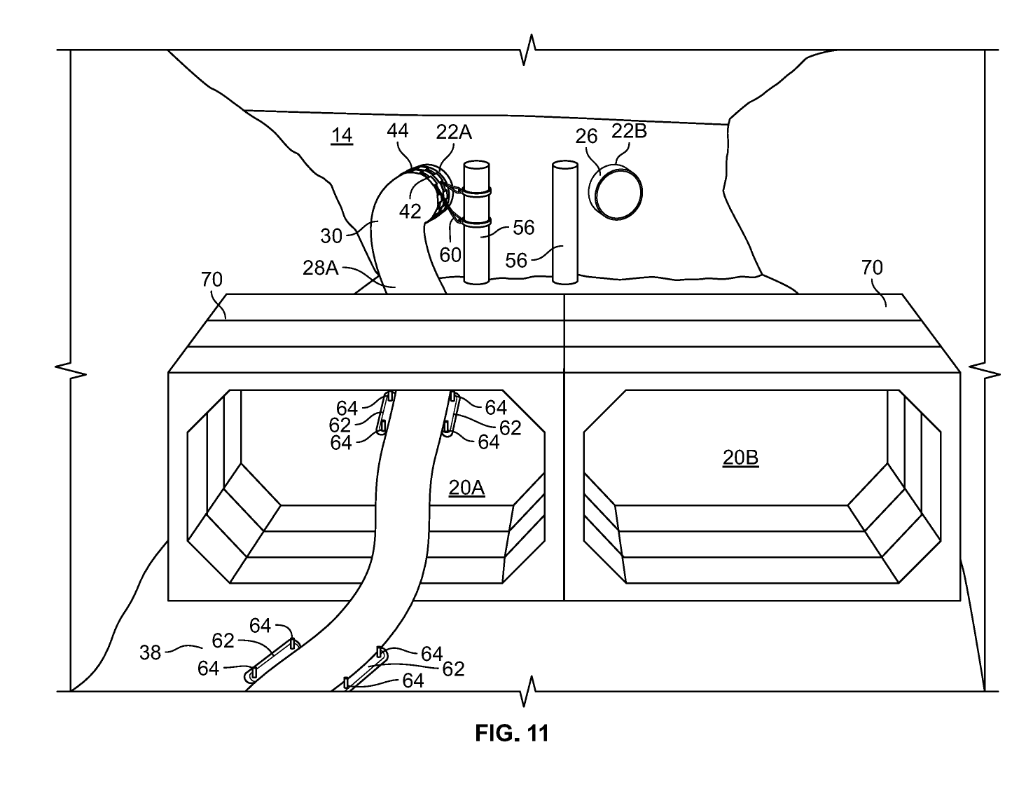

At least one end of the flexible tube is provided with means for securing the tube to a CMP pipe or other substantially rigid conduit. In a preferred embodiment, the securing means comprises a plurality of pull straps 46 and two rows of belt loops 44 that extend around the circumference of the tube. Two steel cables or nylon tie-down straps 42 pass through the respective belt loops 44 and are cinched tight. Optionally, the cables 42 can be plastic coated. The cables or straps 42 can fit substantially within the helical corrugations of the CMP to thereby resist any tendency to slip off. The cinched cables or straps 42 depress the flexible tube 28 into the corrugations to provide an effective water seal. Additional means for sealing the tube to the pipe section may be provided, but are unnecessary in most applications. The pull straps preferably include loops on the end. Optionally, the end of the flexible tube 28 are flared 72 to a larger diameter to facilitate securing the tube to the end of a pipe section 22, as shown for example in FIG. 5. Another option is to anchor the connection of the flexible tube to the pipe section with a post or deadman 56, as shown in FIGS. 7-11.

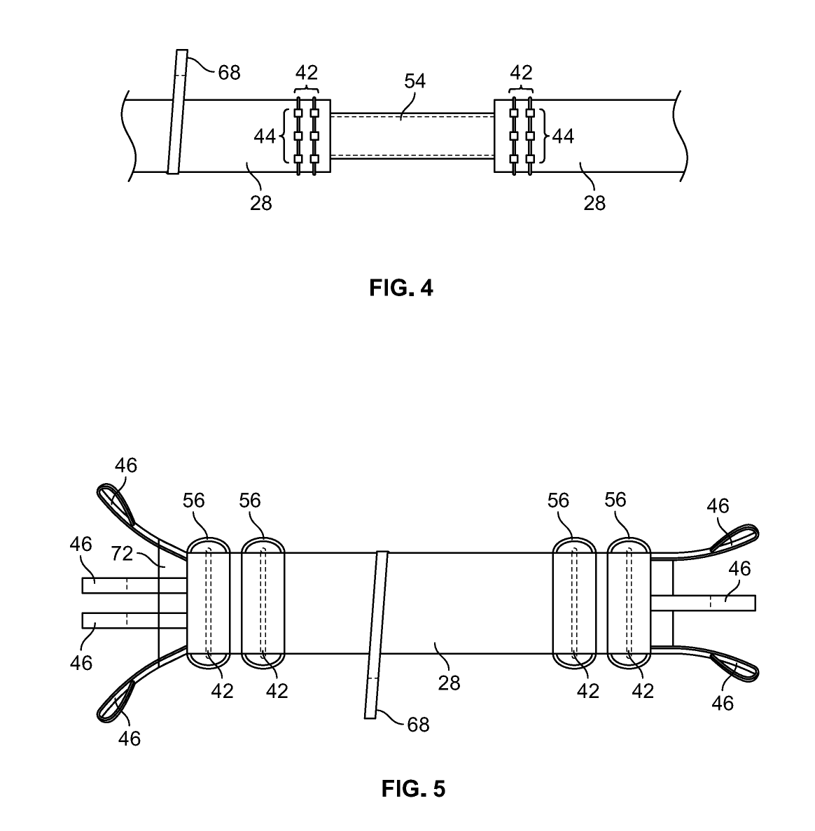

Referring to FIGS. 4-5, the system may optionally include one or more connectors 54, such a CMP sections, to join multiple flexible tubes 28. Positioning straps 68 may be added for the purpose of lifting and moving flexible tube 28 during construction and/or to secure flexible tube 28 while in use, e.g., by staking the strap to the ground. The positioning strap 68 can be secured to the flexible tube by welding and preferably has a looped end.

FIG. 5 shows another embodiment of the flexible tube wherein the belt loops are replaced with circumferential sleeves 56. Cables or straps 42 are wound through the sleeves to secure the sleeve to the pipe.

FIG. 6 shows a flexible tube 28 traversing to rough terrain. The flexible tube 28 lies on and conforms to the natural terrain, and is held down by the weight of the water within the tube. Where the flexible tube 28 crosses a particularly deep hole or trench, a flume 66 may be employed to support the flexible tube 28 as it traverses the hole or trench.

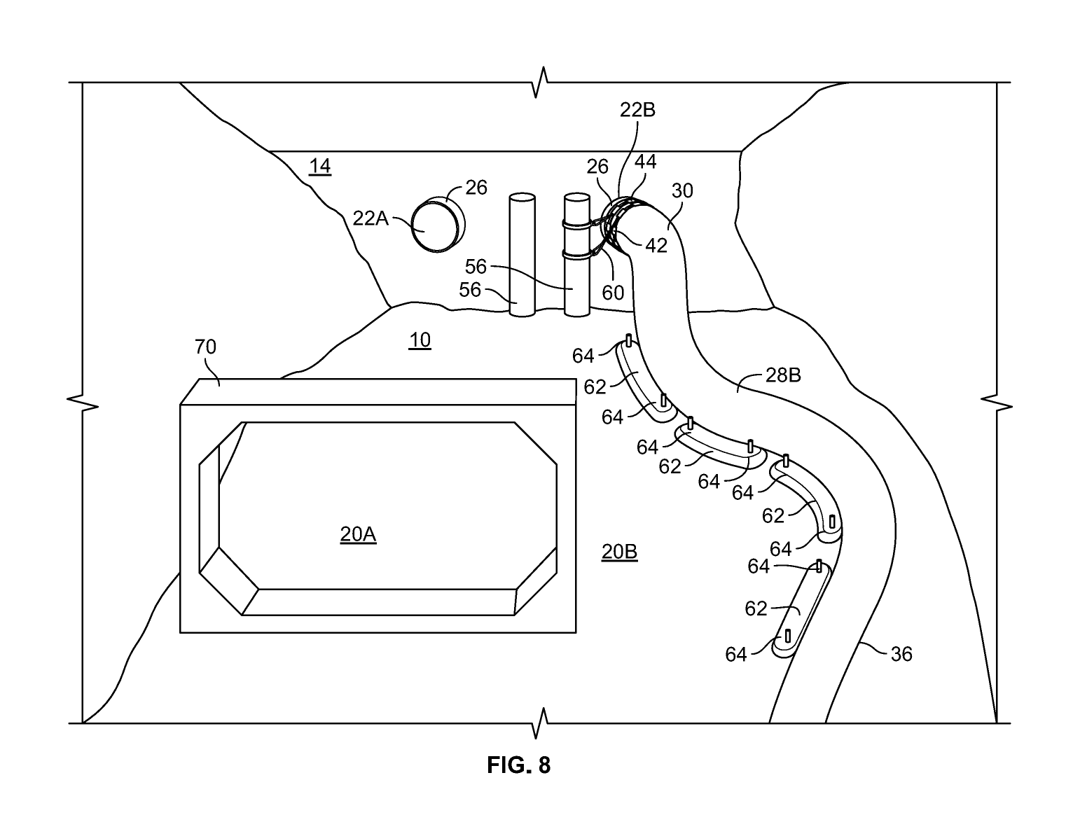

In reference to FIG. 1 and FIGS. 7-11, a method embodiment of the invention includes the following steps: A cofferdam 14 is constructed in a streambed 10 upstream of the job site 20 with at least one, preferably two rigid pipes 22A, 22B embedded therein. A flexible tube 28B is secured to the downstream end 26 of one pipe 22B and is routed along the natural streambed and through the job site area 20B, avoiding a first job site area 22A. Preferably, a post or deadman 56 is provided. Flexible tube 28B pipe section 22B can be secured to the deadman with one or more anchor cables 60. Flexible tube 28b can be installed to curve through the job site 20B. The tube conforms to the ground surface and can traverse rough terrain and grade changes. Flow is initiated via flexible tube 20B. A valve or plug 34 is used to prevent flow though rigid pipe 22A. The weight of the water in flexible tube 28b holds the tube in place by gravity. Optionally means can be employed to secure the flexible tube in place, such as steel bands with tie-downs or wattles 62 held in place with stakes 64. A first part of the structure is shown schematically in FIG. 8 as a precast box culvert section 70. With water being diverted around job site area 20A via flexible tube 28B, construction can proceed in dry conditions in job site area 20A.

As construction progresses, the other flexible tube 28A is secured to rigid pipe 22A and routed around or through the job site on another path. The flexible tube 28A is preferably further secured to the rigid pipe 22a by securing the upstream end 30 to deadman 56 with one or more anchor cables 60. Rigid pipe 22B is then closed with a valve or plug 24, and rigid pipe 22A is opened to divert flow around job site area 20B, i.e., through job site 20A. The now substantially empty flexible tube 28b can be rolled up or moved to permit construction of the structure in job site part 20B.

Flow paths can be modified during construction. Positioning straps 68 may be used to adjust a flow path as needed. Positioning straps 68 can be staked down to the streambed to secure the flexible tube 28 in place. Further, as construction progresses, water diversion paths can be flipped, added or modified in a simple, quick and cost-effective manner.

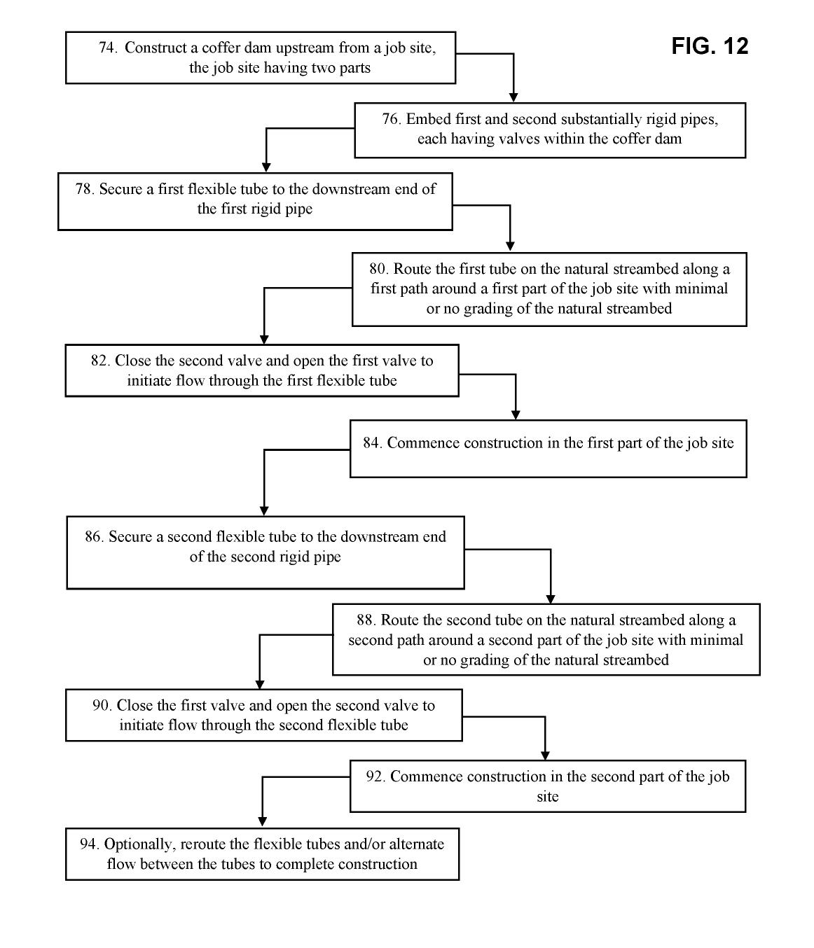

FIG. 12 is a flow chart of one embodiment of method in accordance with the invention. A cofferdam is constructed upstream from a job site 74. Optionally, a cofferdam maybe constructed downstream of the job site if needed, depending on site conditions. First and second substantially rigid pipes, each having valves, are embedded within the upstream cofferdam 76. A first flexible tube is secured to the downstream end of the first substantially rigid pipe 78. The first tube is routed on the natural streambed along a first path around a first part or area of the job site with minimal or no grading of the natural streambed 80. The second valve is closed and the first valve is opened to initiate flow through the first flexible tube 82. Construction then commences in the first part of the job site, while water flow is diverted around the construction 84.

A second flexible tube is secured to the downstream end of the second substantially rigid pipe 86. The second tube is routed on the natural streambed along a second path around a second part of the job site with minimal or no grading of the natural streambed 88. At the appropriate time, the first valve is closed and the second valve is opened to initiate flow through the second flexible tube 90. If necessary the first tube can be rolled up, removed, or moved. Construction then commences in the second part of the job site 92.

Optionally, the flexible tubes can be moved, rerouted and/or flow alternated between the tubes to complete construction 94.

While preferred embodiments of the invention have been herein illustrated and described, it is to be appreciated that certain changes, rearrangements and modifications may be made therein without departing from the scope of the invention as defined by the appended claims.

1. A water diversion system for a job site in a streambed comprising:
a cofferdam in the streambed upstream of said job site having an upstream side and a downstream side;
at least one section of substantially rigid pipe embedded in the cofferdam, the pipe section having an upstream end and a downstream end;
at least one flexible tube having at least one end configured for connection to the downstream end of the at least one pipe section and configured to lie on the streambed and traverse the job site; and
at least one valve or plug, engaged with the pipe section and configured to open or close flow within the pipe section;
wherein when the valve is open water is diverted through the flexible tube around or through the job site on a first path, and wherein by closing the valve the flexible tube can be rerouted along the streambed and around or through the job site on a second path.

2. The water diversion system of claim 1 wherein the flexible tube comprises a layer of filter fabric on at least a portion of the outer surface of the flexible tube.

3. The water diversion system of claim 1, wherein the flexible tube is connected to the rigid pipe with one or more cables wound through belt loops or sleeves on the one end of the flexible tube.

4. The water diversion system of claim 3, wherein the streambed comprises rough terrain in its natural state, characterized by steep grades and changes in slope, and the flexible tube is placed in the natural streambed substantially without grading or otherwise disturbing the natural streambed.

5. The water diversion system of claim 1, wherein the rigid pipe is a CMP pipe.

6. The water diversion system of claim 1, wherein the flexible tube has a plurality of longitudinal straps extending from one end.

7. The water diversion system of claim 1, further comprising at least one positioning strap attached to a central portion of the flexible tube.

8. The water diversion system of claim 7, wherein the positioning strap has a looped end.

9. The water diversion system of claim 1, further comprising a second flexible tube, and a substantially rigid connector connecting a downstream end of the first said flexible tube with an upstream end of said second flexible tube.

10. The water diversion system of claim 1, further comprising a deadman adjacent the downstream end of the substantially rigid pipe and wherein the flexible tube is secured in place to the deadmen.

11. The water diversion system of claim 1, further comprising a plurality of wattles adjacent the flexible tube.

12. The water diversion system of claim 1, further comprising at least one flume supporting a portion of the flexible tube.

13. The water diversion system of claim 1, wherein the flexible tube is constructed of high density polyethylene or reinforced polyethylene.

14. The water diversion system of claim 1, further comprising a second substantially rigid pipe section in the cofferdam, a second valve in the second pipe section, and a second flexible tube connected to the second pipe section, wherein the second flexible tube is configured to lie on the streambed and traverse the job site on a second path.

15. A water diversion system for a job site in a natural streambed comprising:
a cofferdam in the streambed upstream of the job site having an upstream side and a downstream side;
at least two sections of substantially rigid pipe embedded in the cofferdam, each pipe section having an upstream end and a downstream end;
at least two valves or plugs, each engaged with a respective one of the pipe sections and configured to open or close flow within the pipe section;
a first flexible plastic tube having an upstream end connected to the downstream end of at least one of the pipe sections and configured to lie on the natural streambed and traverse the job site on a first path; and
a second flexible plastic tube having an upstream end connected to the downstream end of a second one of the pipe sections and configured to lie on the natural streambed and traverse the job site on a second path.

16. The water diversion system of claim 15, wherein the natural streambed comprises rough terrain, characterized by steep grades and changes in slope, and the flexible tubes are placed in the natural streambed substantially without grading or otherwise disturbing the natural streambed.

17. A method of diverting water around a job site in a streambed comprising the steps of:
constructing a cofferdam upstream from the job site;
embedding first and second rigid pipes, each having valves, within the cofferdam;
securing a first flexible tube to the downstream end of the first rigid pipe;
routing the first tube on or along the streambed and around a first part of the job site on a first path and terminate downstream from the job site;
closing the second valve and opening the first valve to cause water to flow through the first tube along the first path;
securing a second flexible tube to the downstream end of the second rigid pipe;
routing the second tube on or along the streambed and around a second part of the job site on a second path, terminating downstream from the job site;
closing the first valve and opening the second valve to cause water to flow through the second tube along the second path.

18. The water diversion method of claim 17, wherein the streambed comprises rough terrain in its natural state, characterized by steep grades and changes in slope, and wherein the flexible tubes are placed in the natural streambed substantially without grading or otherwise disturbing the natural streambed.

19. The method of claim 17, further comprising the step of staking wattles against the flexible tubes to secure the tubes in place.

20. The method of claim 17, further comprising the steps of providing a deadman at the upstream end of the flexible tubes and anchoring the flexible tubes to the deadman.
